(19) United States
(12) Patent Application Publication
(10) Pub. No.: US 2006/0284875 A1
(43) Pub. Date: Dec. 21, 2006

(54) Digital video data transmitting apparatus and display apparatus

(75) Inventor: Kwang-hoon Jeon, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/447,244

(22) Filed: Jun. 6, 2006

(30) Foreign Application Priority Data
Jun. 20, 2005 (KR) 2005-0053176

(51) Int. Cl. G06F 13/14

(52) U.S. Cl. 345/520

(57) ABSTRACT

A digital video data transmitting apparatus and display apparatus for transmitting digital video data to a panel driving part are provided. The apparatus includes a video data output part which outputs a first digital video signal having even data and odd data of an n-bit bus width or a second digital video signal having even data and odd data of an m-bit bus width; a plurality of video data transmitting parts which convert the digital video data into digital video data having even data and odd data of a k-bit bus width, according to a digital video data transmitting method, and which transmits the converted digit video data to the panel driving part; and a pathway selection part which selects between the data of the first digital video signal and the data of the second digital video signal when the second digital video signal is output.

### CROSS-REFERENCE TO RELATED APPLICATIONS

This application claims priority from Korean Patent Application No. 2005-0053176, filed on Jun. 20, 2005, in the Korean Intellectual Property Office, the disclosure of which is incorporated herein by reference.

### BACKGROUND OF INVENTION

1. Field of Invention

The present invention relates to a digital video data transmitting apparatus and a display apparatus, and more particularly, to a digital video data transmitting apparatus and a display apparatus which can be adapted to a flat display panel having various resolutions and gradations.

2. Description of the Related Art

Recently, flat displays have been variously developed, and Liquid Crystal Display (LCD) Panels and Plasma Display Panels (PDP) have become popular.

The LCD panel displays an image on a screen by using the physical properties of liquid crystal whereby a transmittance is changed by a charging force, and is controlled according to a panel driving part.

The panel driving part drives the LCD panel with digital video data supplied from a digital video data transmitting apparatus such as a video processor, which processes the video data in the digital method.

Recently, a Low Voltage Differential Signaling (LVDS) method and a Transition Minimized Differential Signaling (TMDS) method have been proposed as digital video data transmitting methods.

The LVDS method sends the digital information to the panel driving part through copper lines at high speed, thereby reducing the noise, electromagnetic interference (EMI), and power of consumption.

The TMDS method is used in a desktop computer, where the transmitting line of the video data is relatively long, because it considerably reduces the loss of the signal generated when the digital video data is transmitted over a long line.

In either the LVDS method or the TMDS method, a high frequency clock signal is controlled by a two branch method. A source drive of the panel driving part is divided into two groups which are an odd numbered source drive IC and an even numbered source drive IC. Therefore, the digital video data is transmitted from the digital video data transmitting apparatus to the panel driving part as digital video data of the two groups, i.e., even data and odd data.

In a case where the LVDS method or the TMDS method is applied to the display apparatus, a receiving chip such as a LVDS receiver or a TMDS receiver for receiving the digital video data of the LVDS method or the TMDS method, respectively, is provided in a side of the panel driving part, and a transmitting chip such as a LVDS transmitter or a TMDS transmitter corresponding thereto is provided in a side of the digital video data transmitting apparatus.

However, currently, there is a limit to the volume of the existing receiving chip or transmitting chip that is applied to the display apparatus of the LVDS method or the TMDS method because output resolution or gradation of the flat display panel becomes high and a dynamic range of the video data becomes large.

For example, in a case where the existing receiving chip or the transmitting chip transmits the even data and the odd data of an 8-bit bus width, a flat display panel capable of displaying video data of more than an 8-bit bit bus width cannot use the transmitting chip and the receiving chip designed to use an 8-bit bus width.

Particularly, in the case where the manufacturer of the flat display panel and the panel driving part is different from the manufacturer of the digital video data transmitting apparatus, the manufacturer of the digital video data transmitting apparatus must provide both an 8-bit exclusive digital video data transmitting apparatus and an 8-bit exclusive digital video data transmitting apparatus for more than 8-bit bus width (for example, a 12-bit exclusive digital video data transmitting apparatus).

That is, referring to FIG. 1, the digital video data transmitting apparatus, which has a video signal output part 110a outputting digital video data of an 8-bit bus width, and a transmitting chip 120a, should be connected with a receiving chip 130a of the panel driving part capable of receiving digital video data of an 8-bit bus width. The digital video data transmitting apparatus, which has a video signal output part 110b outputting digital video data of an 12-bit bus width, and a transmitting chip 120b, should be connected with a receiving chip 130b of the panel driving part capable of receiving digital video data of a 12-bit bus width.

### SUMMARY OF THE INVENTION

Accordingly, an aspect of the present invention provides a digital video data transmitting apparatus and a display apparatus which can transmit a digital video data of an n-bit bus width which is larger than an m-bit bus width by using a plurality of digital video data transmitting chips and receiving chips capable of processing the digital video data of the m-bit bus width.

Further, another aspect of the present invention provides a digital video data transmitting apparatus and a display apparatus which can selectively transmit one of a digital video data of n-bit bus width and a digital video data of m-bit bus width by simple circuit operation. According to an exemplary embodiment of the present invention, there is provided a digital video data transmitting apparatus for transmitting a digital video data to a panel driving part driving a flat display panel comprises a video data output part which outputs one of a first digital video signal having even data and odd data of an n-bit bus width and a second digital video signal having even data and odd data of an m-bit bus width which is smaller than the n-bit bus width; a plurality of video data transmitting part to convert the digital video data into digital video data having even data and odd data of a k-bit bus width, which is smaller than the n-bit bus width, according to a digital video data transmitting method and which transmits the converted digit video data to the panel driving part; and a pathway selection part which transmits the even data of the first digital video signal to at least one of the plurality of video data transmitting parts and which transmits the odd data of the first digital video signal to the remainder of the plurality of video data transmitting parts when the first digital video signal is output from the video data output part, and which transmits the even data and the odd data of the second digital video signal to at least one of the plurality of video data transmitting parts when the second digital video signal is output from the video data output part.

According to an aspect of the present invention, the digital video data transmitting method comprises one of a LVDS method and a TMDS method.

According to an aspect of the present invention, the video data transmitting part comprises a first video data transmitting part and a second video data transmitting part for transmitting the digital video data having even data and odd data of an 8-bit bus width to the panel driving part, in the case where the n-bit bus width is a 12-bit bus width, the m-bit bus width is an 8-bit bus width and the k-bit bus width is an 8-bit bus width; and the pathway selection part transmits the even data and the odd data of the second digital video signal to the first video data transmitting part when the second digital video signal is output from the video data output part, and transmits the even data and the odd data of the first digital video signal to the first video data transmitting part and the second video data transmitting part respectively when the first digital video signal is output from the video data output part.

According to an aspect of the present invention, the first video data transmitting part and the second video data transmitting part comprises even data input pins of an 8-bit but width and odd data input pins of an 8-bit bus width, respectively; and the video signal output part comprises a first even data output pin connected to the even data input pins of the 8-bit bus width of the first video data transmitting part, a second even data output pin selectively connected to a part of the odd data input pins of the 8-bit bus width of the first video data transmitting part, first odd data output pins connected to a part of the even data input pins of the 8-bit bus width of the second video data transmitting part, second odd data output pins connected to the rest of the odd data input pins of the 8-bit bus width of the first video data transmitting part and the remainder of the even data input pins of the 8-bit bus width of the second video data transmitting part, and third odd data output pins connected to a part of the odd data input pins of the 9-bit bus width of the second video data transmitting part.

According to an aspect of the present invention, the pathway selection part comprises a switching part to connect the second even data output pins of the video signal output part to a part of the odd data input pins of the 8-bit bus width of the first video data transmitting part when the video signal transmitting part outputs the first digital video signal, and to connect the first odd data output pins of the video signal output part to the part of the odd data input pins of the 8-bit bus width of the first video data transmitting part when the video signal transmitting part outputs the second digital video signal.

According to another exemplary embodiment of the present invention, there is provided a display apparatus having a flat display panel comprises a panel driving part which drives the flat display panel; a video data output part which outputs one of a first digital video signal having even data and odd data of an n-bit bus width and a second digital video signal having even data and odd data of an m-bit bus width, which is smaller than the n-bit bus width; a plurality of video data transmitting parts each of which converts the digital video data into digital video data having even data and odd data of a k-bit bus width, which is smaller than the n-bit bus width, according to a digital video data transmitting method and which transmits the converted digital video data to the panel driving part; and a pathway selection part which transmits the even data of the first digital video signal to at least one of the plurality of video data transmitting parts and which transmits the odd data of the first digital video signal to the remainder of the plurality of video data transmitting parts when the first digital video signal is output from the video data output part, and which transmits the even data and the odd data of the second digital video signal to at least one of the plurality of video data transmitting parts when the second digital video signal is output from the video data output part.

According to an aspect of the present invention, the digital video data transmitting method comprises one of a LVDS method and a TMDS method.

According to an aspect of the present invention, the video data transmitting part comprises a first video data transmitting part and a second video data transmitting part for transmitting the digital video data having even data and odd data of an 8-bit bus width to the panel driving part, in the case where the n-bit bus width is a 12-bit bus width and the m-bit bus width is an 8-bit bus width and the k-bit bus width is an 8-bit bus width; and the pathway selection part to transmitting the second digital video signal to the first video data transmitting part when the second digital video signal is output from the video data output part, and to transmitting the even data and the odd data of the first digital video signal to the first video data transmitting part and the second video data transmitting part respectively when the first digital video signal is output from the video data output part.

According to an aspect of the present invention, the panel driving part comprises at least one video data receiving part for receiving the digital video signal from the video data transmitting, and a timing controller for driving the flat display panel on the basis of the digital video signal received through the video data receiving part; and the timing controller drives the flat display panel on the basis of the digital video signal received through the video data receiving part connected with the first video data transmitting part, in a case where the timing controller operates based on the even data and the odd data of the 8-bit bus width.

According to an aspect of the present invention, the video data transmitting part comprises a first video data transmitting part and a second video data transmitting part for transmitting the digital video data having even data and odd data of an 8-bit bus width to the panel driving part, in the case where the n-bit bus width is a 12-bit bus width and the m-bit bus width is an 8-bit bus width and the k-bit bus width is an 8-bit bus width; and the timing controller drives the flat display panel by recognizing the digital video signal received through the video data receiving part connected to the first video data transmitting part as the even data of the 12-bit bus width, and by recognizing the digital video signal received through the video data receiving part connected to the second video data transmitting part as the odd data of the 12-bit bus width when the timing controller operates on the basis of the even data and the odd data of the 12-bit bus width.

According to another exemplary embodiment of the present invention, a display apparatus having a flat display panel comprises a panel driving part which drives the flat display panel; a video data output part which outputs a digital video data having even data and odd data of an n-bit bus width; a plurality of video data transmitting part each of which converts the digital video data into digital video data having even data and odd data of a k-bit bus width, which is smaller than the n-bit bus width, according to a digital video data transmitting method and which transmits the converted digit video data to the panel driving part; and a pathway selection part which transmits the even data of the n-bit bus width of the digital video data output from the video data output part to at least one of the plurality of video data transmitting parts, and which transmits the odd data of the n-bit bus width of the digital video data to the remainder of the plurality of video data transmitting parts.

According to an aspect of the present invention, the digital video data transmitting method comprises one of a LVDS method and a TMDS method.

According to an aspect of the present invention, the video data transmitting part comprises a first video data transmitting part and a second video data transmitting part for transmitting the digital video data having even data and odd data of an 8-bit bus width to the panel driving part, in the case where the n-bit bus width is a 12-bit bus width and the m-bit bus width is an 8-bit bus width and the k-bit bus width is an 8-bit bus width; and the pathway selection part to transmit the even data and the odd data of the digital video data to the first video data transmitting part and the second video data transmitting part, respectively, when the digital video data is output from the video data output part.

According to an aspect of the present invention, the panel driving part comprises a first video data receiving part connected to the first video data transmitting part and receiving the even data of the digital video data according to a digital video data transmitting method; a second video data receiving part connected to the second video data transmitting part and receiving the odd data of the digital video data according to a digital video data transmitting method; and a timing controller for driving the flat display panel by recognizing the digital video data received through the first video data receiving part as the even data, and by recognizing the digital video data received through the second video data receiving part as the odd data.

### BRIEF DESCRIPTION OF THE DRAWINGS

The above and other aspects of the prevent invention will become apparent and more readily appreciated from the following description of exemplary embodiments, taken in conjunction with the accompany drawings, in which:

FIG. 1 illustrates a transmitting structure of a digital video data of a conventional display apparatus;

FIG. 2 is a control block diagram of a display apparatus according to an exemplary embodiment of the present invention; and

FIGS. 3 and 4 illustrate transmitting structures of the digital video data of the display apparatus according to an exemplary embodiment of the present invention.

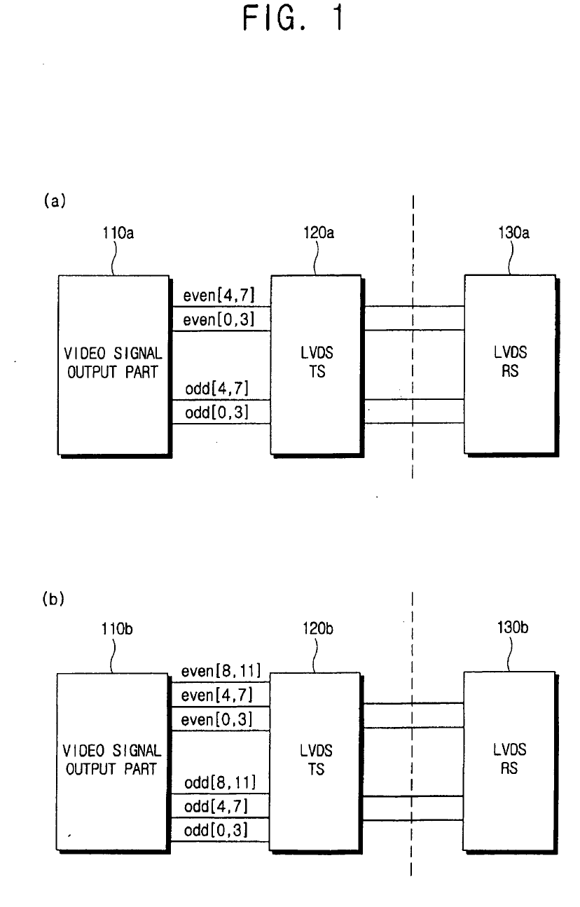

### DETAILED DESCRIPTION OF THE ILLUSTRATIVE, NON-LIMITING EMBODIMENTS OF THE INVENTION

Reference will now be made in detail to the exemplary embodiments of the present invention, examples of which are illustrated in the accompanying drawings, wherein like reference numerals refer to like elements throughout. The embodiments are described below so as to explain the present invention by referring to the figures.

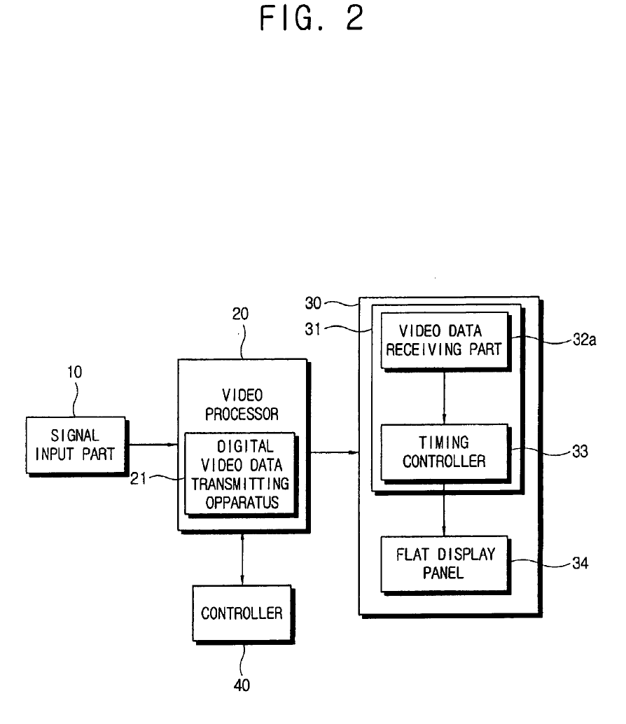

Referring to FIG. 2, a display apparatus according to an exemplary embodiment of the present invention includes a signal input part 10, a video processor 20, a display part 30 and a controller 40 controlling the foregoing elements.

The signal input part 10 receives a video signal output from a video source such as a computer or other video source known in the art. The signal input part 10 may be of various types for receiving video signals according to various formats known in the art. For example, the signal input part 10 may include at least one of a D-Sub connector, a DVI connector, a composite terminal, and a component terminal, or other connectors and terminals known in the art.

The video processor 20 converts the video signal input through the signal input part 10 into digital video data of a format which can be displayed by the display part 30, and then transmits the digital video data to the display part 30.

The video processor 20 includes a digital video data transmitting apparatus 21 which outputs the digital video data to the display part 30 according to a digital video data transmitting method. The digital video data transmitting method between the video processor 20 and the display part 30 may be an LVDS method or a different digital video data transmitting method which divides and transmits the digital video data into even data and odd data, i.e., a TMDS method.

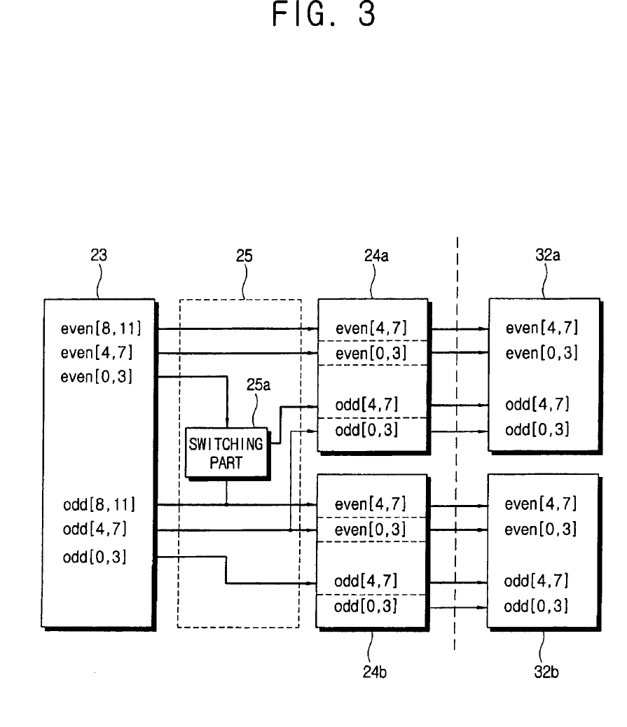

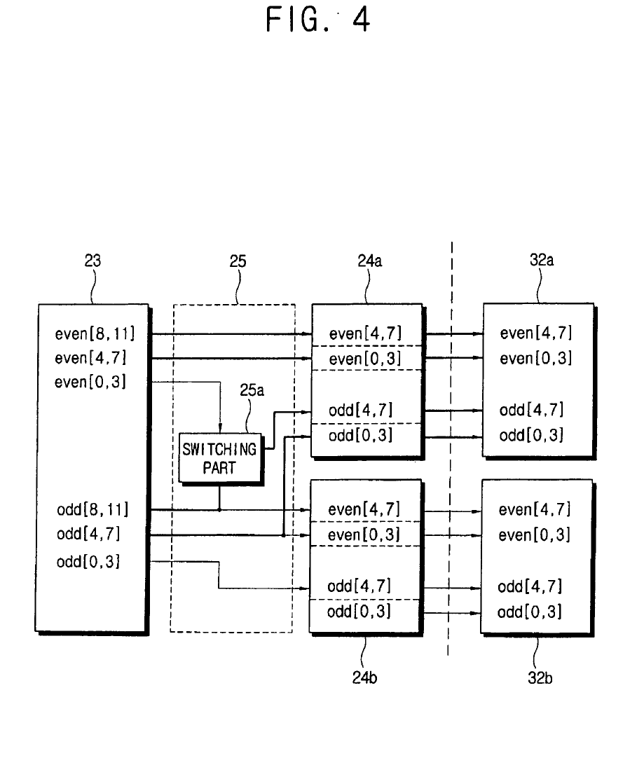

Referring to FIGS. 3 and 4, the digital video data transmitting apparatus 21 according to an exemplary embodiment of the present invention includes a video data output part 23, a plurality of video data transmitting parts 24a, 24b, and a pathway selection part 25.

The video data output part 23 outputs one of a first digital video signal having even data and odd data of an n-bit bus width, and a second digital video signal having even data and odd data of an m-bit bus width which is smaller than the n-bit bus width. Below, an exemplary embodiment in which the n-bit bus width is a 12-bit bus width and the m-bit bus width is an 8-bit bus width will be described.

The video data output part 23 may include a scaler which outputs the digital video data to the display part 30 through the video data transmitting parts 24a, 24b. Further, if an image quality improving part connected to an output terminal of the scaler is provided to improve the image quality displayed on a screen by adjusting secondly the digital video data output from the scaler, the video data output part 23 may also include an appropriate image quality improving part. In such a case, the digital video data output from the scaler is transmitted to the video data transmitting parts 24a, 24b through the image quality improving part.

The video data transmitting parts 24a, 24b convert the digital video data into digital video data having even data and odd data of a k-bit bus width, which is smaller than the n-bit bus width, according to the LVDS method, and then transmit the converted digital video data to a panel driving part 31. As below, an exemplary embodiment where the k-bit bus width is an 8-bit bus width will be described. For example, the video data transmitting parts 24a, 24b according to an exemplary embodiment of the present invention may include a pair of video data transmitting parts 24a, 24b each of which transmit the digital video data having even data and odd data of an 8-bit bus width to the panel driving part 31. Each video data transmitting part 24a, 24b includes a first video data transmitting part 24a and a second video data transmitting part 24b.

When a first digital video signal is output from the video data out part 23, the pathway selection part 25 transmits the even data of the first digital video signal to at least one of the video data transmitting parts 24a, 24b, and transmits the odd data of the first digital video signal to the remainder of the video data transmitting parts 24a, 24b.

For example, when the first digital video signal is output from the video data output part 23, the pathway selection part 25 allows the even data of the first digital video signal to be transmitted to the first video data transmitting part 24a. And then, when the first digital video signal is output from the video data output part 23, the pathway selection part 25 allows the odd data of the first digital video signal to be transmitted to the second video data transmitting part 24b.

Referring to FIG. 3, the first video data transmitting part 24a and the second video data transmitting part 24b may include even data input pins of an 8-bit bus width, and odd data input pins of an 8-bit bus width, respectively. The video data output part 23 may include first even data output pins (e.g. even[4,7], even[8,11]), second even data output pins (e.g. even[0,3]), first odd data output pins (e.g. odd[8,11]), second odd data output pins (e.g. odd[4,7]), and third odd data output pins (e.g. odd[0,3]).

The first even data output pins (e.g. even[4,7], even[8,1]) of the video data output part 23 are connected to the even data input pins of an 8-bit bus width of the first video data transmitting part 24a. That is, 8 bits of the even data output pins of the 12-bit bus width of the video data output part 23 are allocated to the first even data output pins (e.g. even[4,7], even[8,11]).

The second even data output pins (e.g. even[0,3]) of the video data output part 23 are selectively connected to some of the odd data input pins of an 8-bit bus width of the first video data transmitting part 24a (i.e., 4 bits of the odd data input pins among the odd data input pins of the 8-bit bus width). That is, 4 bits of the even data output pins of the 12-bit bus width of the video data output part 23 are allocated to the second even data output pins (e.g. even[0,3]).

The first odd data output pins (e.g. odd[8,11]) of the video data output part 23 are selectively connected to some of the even data input pins of the 8-bit bus width of the second video data transmitting part 24b (i.e., 4 bits of the even data input pins among the even data input pins of the 8-bit bus width). That is, 4 bits of the odd data output pins of the 12-bit bus width of the video data output part 23 are allocated to the first odd data output pins (e.g. odd[8,11]).

The second odd data output pins (e.g. odd[4,7]) of the video data output part 23 are connected to the remainder of the odd data input pins of the 8-bit bus width of the first video data transmitting part 24a and the remainder of the even data input pins of the 8-bit bus width of the second video data transmitting part 24b. In the second odd data output pins (e.g. odd[4,7]) of the video data output part 23, 4 bits of the odd data output pins of the 12-bit bus width are allocated, and the second odd data output pins (e.g. odd[4,7]) 4 bits are respectively connected to 4 bits of the odd data input pins of the first video data transmitting part 24a and 4 bits of the even data input pins of the second video data transmitting part 24b.

The third odd data output pins (e.g. odd[0,3]) of the video data output part 23 are connected to some of the odd data input pins of the 8-bit bus width of the second video data transmitting part 24b. The third odd data output pins (e.g. odd[0,3]) and the odd data input pins of the second video data transmitting part 24b are respectively allocated by 4-bit words.

When the video signal output part outputs the first digital video signal, the pathway selection part 25 may include a switching part 25a connecting the second even data output pins (e.g. even[0,3]) of the video signal output part to 4-bits of the odd data input pins of the first video data transmitting part 24a.

Accordingly, in the case where the first digital video signal is output from the video data output part 23, referring to FIG. 3, even data of a 12-bit bus width output from the even data output pins of the video data output part 23 is transmitted to the first video data transmitting part 24a through 8-bits of the even data input pins and 4-bits of the odd data input pins of the first video data transmitting part 24a by the pathway selection part 25 comprised of the switching part 25a.

And then, odd data of a 12-bit bus width output from the odd data output pins of the video data output part 23 is transmitted to the second video data transmitting part 24b through 8-bits of the even data input pins and 4-bits of the odd data input pins of the second video data transmitting part 24b by the pathway selection part 25.

Meanwhile, a transmitting process of the digital video data in the case where the video data output part 23 according to an exemplary embodiment of the present invention outputs a second digital video signal will be described with reference to the FIG. 4.

First, the video data output part 23 outputs even data of the an 8-bit bus width through 8-bits of the first even data output pins (e.g. even[4,7], even[8,11])8-bit. The even data of the 8-bit bus width of the second digital video signal, which are output through the first even data output pins (e.g. even[4,7], even[8,11]) of the 8-bit of the video data output part 23, is input to 8-bits of the even data input pins of the first video data transmitting part 24a.

And then, the video data output part 23 outputs 8-bits of the odd data through 4-bits of the first odd data output pins (e.g. odd[8,11]) and 4-bits of the second odd data output pins (e.g. odd[4,7])4-bit. The odd data of a 4-bit bus width output from the first odd data output pins (e.g. odd[8, 1]) is input to 4-bits of the odd data input pins of the first video data transmitting part 24a. And then, the remaining 4-bits of the odd data output from the second odd data output pins (e.g. odd[4,7]) is input to the remaining 4-bits of the odd data input pins of the first video data transmitting part 24a.

Accordingly, in the case where the second digital video signal is output from the video data output part 23, both the even data of the 8-bit bus width and the odd data of the 8-bit bus width of the second digital video signal are input to the first video data transmitting part 24a.

Referring to FIG. 2, the display part 30 according to an exemplary embodiment of the present invention includes a flat display panel 34 displayed with the image, and the panel driving part 31 driving the flat display panel 34.

The flat display panel 34 displays the image on the screen by controlling the panel driving part 31. The flat display panel 34 according to an embodiment of the present invention may be provided as one of an LCD panel and an PDP, or other type of display panel known in the art.

The panel driving part 31 may include a video data receiving part 32 for receiving the digital video data from the first video data transmitting part 24a and the second video data transmitting part 24b of the digital video data transmitting apparatus 21, and a timing controller 33 for driving the flat display panel 34 on the basis of the digital video data received through the video data receiving part 32.

Referring to FIGS. 3 and 4, the video data receiving part 32 according to an exemplary embodiment of the present invention includes a first video data receiving part 32a and a second video data receiving part 32b to be respectively connected to the first video data transmitting part 24a and the second video data transmitting part 24b.

The first video data receiving part 32a and the second video data receiving part 32b receive the digital video data from the first video data transmitting part 24a and the second video data transmitting part 24b, respectively, according to the LVDS method or the TMDS method. The first video data receiving part 32a and the second video data receiving part 32b, respectively, correspond to the data bus width of the first video data transmitting part 24a and the second video data transmitting part 24b, and receive and process the even data of an 8-bit bus width and the odd data of an 8-bit bus width.

The first video data transmitting part 24a transmits the data, which is input through the even data input part of an 8-bit bus width, to the first video data receiving part 32a through the even data transmitting part of an 8-bit bus width, and transmits the data, which is input through the odd data input part of an 8-bit bus width, to the first video data receiving part 32a through the odd data transmitting part of an 8-bit bus width.

Similarly, the second video data transmitting part 24b transmits the data, which is input through the even data input part of an 8-bit bus width, to the second video data receiving part 32b through the even data transmitting part of an 8-bit bus width, and transmits the data, which is input through the odd data input part of an 8-bit bus width, to the second video data receiving part 32b through the odd data transmitting part of an 8-bit bus width.

The data, which are transmitted from the first video data transmitting part 24a and the second video data transmitting part 24b to the first video data receiving part 32a and the second video data receiving part 32b, are controlled by the first digital video signal and the second digital video signal.

In the case where the timing controller 33 according to an exemplary embodiment of the present invention operates on the basis of the even data of an 8-bit bus width and the odd data of an 8-bit bus width, the display part 30 according to an exemplary embodiment of the present invention is connected to an image processor having a digital video signal output device which outputs the second digital video signal. Accordingly, the timing controller 33 drives the flat display panel 34 on the basis of the digital video signal which has the even data of an 8-bit bus width and the odd data of an 8-bit bus width received through the first video data receiver 32a.

In the case where the timing controller 33 according to an exemplary embodiment of the present invention operates on the basis of the even data of a 12-bit bus width and the odd data of a 12-bit bus width, the display part 30 according to an exemplary embodiment of the present invention is connected to the image processor having the digital video signal output device which outputs the first digital video signal. Accordingly, the timing controller 33 recognizes the data of the 12-bit bus width received through the first video data receiving part 32a as the even data, and recognizes the data of the 12-bit bus width received through the second video data receiving part 32b as the odd data, thereby driving the flat display panel 34.

In the case where the video data output part 23 of the digital video signal output device according to an exemplary embodiment of the present invention can output selectively the first digital video signal of a 12-bit bus width and the second digital video signal of an 8-bit bus width, the output types of the digital video data output from the first video data transmitting part 24a and the second video data transmitting part 24b may be changed by operating the circuit of the switching part 25a of the pathway selection part 25. Therefore, the digital video signal output device of the 8-bit or 12-bit is coupled to the display part 30 of the 8-bit or 12-bit, thereby attaining the various combinations.

Although a few exemplary embodiments of the present invention have been shown and described, it will be appreciated by those skilled in the art that changes may be made in these exemplary embodiments without departing from the principles and spirit of the invention, the scope of which is defined in the appended claims and their equivalents.

What is claimed is:

1. A digital video data transmitting apparatus for transmitting digital video data to a panel driving part which drives a flat display panel, the digital video data transmitting apparatus comprising:
a video data output part which outputs one of a first digital video signal having even data and odd data of an n-bit bus width and a second digital video signal having even data and odd data of an m-bit bus width which is smaller than the n-bit bus width;
a plurality of video data transmitting parts which convert the digital video data into digital video data having even data and odd data of a k-bit bus width, which is smaller than the n-bit bus width, according to a digital video data transmitting method, and transmit the converted digital video data to the panel driving part; and
a pathway selection part which transmits the even data of the first digital video signal to at least one of the plurality of video data transmitting parts and transmits the odd data of the first digital video signal to the remainder of the plurality of video data transmitting parts if the first digital video signal is output from the video data output part, and transmits the even data and the odd data of the second digital video signal to at least one of the plurality of video data transmitting parts if the second digital video signal is output from the video data output part.

2. The digital video data transmitting apparatus according to claim 1, wherein the digital video data transmitting method comprises one of a low voltage differential signaling method and a transition minimized differential signaling method.

3. The digital video data transmitting apparatus according to claim 2, wherein the video data transmitting part comprises a first video data transmitting part and a second video data transmitting part which transmit the digital video data having the even data and the odd data of 8-bit bus width to the panel driving part, in the case where the n-bit bus width is a 12-bit bus width, the m-bit bus width is an 8-bit bus width and the k-bit bus width is an 8-bit bus width; and
wherein the pathway selection part transmits the even data and the odd data of the second digital video signal to the first video data transmitting part if the second digital video signal is output from the video data output part, and transmits the even data and the odd data of the first digital video signal to the first video data transmitting part and the second video data transmitting part, respectively, if the first digital video signal is output from the video data output part.

4. The digital video data transmitting apparatus according to claim 3, wherein the first video data transmitting part and the second video data transmitting part each comprises even data input pins of an 8-bit bus width and odd data input pins of an 8-bit bus width, and
wherein the video signal output part comprises first even data output pins connected to 8-bits of the even data input pins of the first video data transmitting part, second even data output pins selectively connected to a part of the odd data input pins of an 8-bit bus width of the first video data transmitting part, first odd data output pins connected to a part of the even data input pins of an 8-bit bus width of the second video data transmitting part, second odd data output pins connected to the remainder of the odd data input pins of an 8-bit bus width of the first video data transmitting part and the remainder of the even data input pins of the 8-bit bus width of the second video data transmitting part, and third odd data output pins connected to a part of the odd data input pins of an 8-bit bus width of the second video data transmitting part.

5. The digital video data transmitting apparatus according to claim 4, wherein the pathway selection part comprises a switching part which connects the second even data output pins of the video signal output part to a part of the odd data input pins of the 8-bit bus width of the first video data transmitting part if the video signal transmitting part outputs the first digital video signal, and connects the first odd data output pins of the video signal output part to the part of the odd data input pins of the 8-bit bus width of the first video data transmitting part when the video signal transmitting part outputs the second digital video signal.

6. A display apparatus having a flat display panel, the display apparatus comprising:
a panel driving part which drives the flat display panel;
a video data output part which outputs one of a first digital video signal having even data and odd data of an n-bit bus width and a second digital video signal having even data and odd data of an m-bit bus width which is smaller than the n-bit bus width;
a plurality of video data transmitting parts which convert the digital video data into digital video data having even data and odd data of a k-bit bus width, which is smaller than the n-bit bus width, according to a digital video data transmitting method, and transmit the converted digital video data to the panel driving part; and
a pathway selection part which transmits the even data of the first digital video signal to at least one of the plurality of video data transmitting parts and which transmits the odd data of the first digital video signal to the remainder of the plurality of video data transmitting parts if the first digital video signal is output from the video data output part, and which transmits the even data and the odd data of the second digital video signal to at least one of the plurality of video data transmitting parts if the second digital video signal is output from the video data output part.

7. The display apparatus according to claim 6, wherein the digital video data transmitting method comprises one of a low voltage differential signaling method and a transition minimized differential signaling method.

8. The display apparatus according to claim 7, wherein the video data transmitting part comprises a first video data transmitting part and a second video data transmitting part which transmit the digital video data having the even data and the odd data of 8-bit bus width to the panel driving part, in the case where the n-bit bus width is a 12-bit bus width and the m-bit bus width is an 8-bit bus width and the k-bit bus width is an 8-bit bus width; and
wherein the pathway selection part transmits the second digital video signal to the first video data transmitting part when the second digital video signal is output from the video data output part, and transmits the even data and the odd data of the first digital video signal to the first video data transmitting part and the second video data transmitting part, respectively, if the first digital video signal is output from the video data output part.

9. The display apparatus according to claim 6, wherein the panel driving part comprises at least one video data receiving part which receives the digital video signal from one of the plurality of video data transmitting parts, and a timing controller which drives the flat display panel based on the digital video signal received through the at least one video data receiving part connected with the first video data transmitting part, in a case where the timing controller operates based on even data and odd data of an 8-bit bus width.

10. The display apparatus according to claim 9, wherein each of the plurality of video data transmitting parts comprise a first video data transmitting part and a second video data transmitting part which transmit the digital video data having even data and odd data of an 8-bit bus width to the panel driving part, in a case where the n-bit bus width is a 12-bit bus width and the m-bit bus width is an 8-bit bus width and the k-bit bus width is an 8-bit bus width; and
wherein the timing controller drives the flat display panel by recognizing the digital video signal received through the video data receiving part connected to the first video data transmitting part as the even data of a 12-bit bus width, and by recognizing the digital video signal received through the video data receiving part connected to the second video data transmitting part as the odd data of the 12-bit bus width if the timing controller operates on the basis of the even data and the odd data of the 12-bit bus width.

11. A display apparatus having a flat display panel, comprising:
a panel driving part which drives the flat display panel;
a video data output part which outputs digital video data having even data and odd data of an n-bit bus width;
a plurality of video data transmitting parts which convert the digital video data into digital video data having even data and odd data of a k-bit bus width, which is smaller than the n-bit bus width, according to a digital video data transmitting method, and transmit the converted digital video data to the panel driving part; and
a pathway selection part which transmits the even data of the n-bit bus width of the digital video data output from the video data output part to at least one of the plurality of video data transmitting parts, and which transmits the odd data of the n-bit bus width of the digital video data to the remainder of the plurality of video data transmitting parts.

12. The display apparatus according to claim 11, wherein the digital video data transmitting method comprises one of a low voltage differential signaling method and a transition minimized differential signaling method.

13. The display apparatus according to claim 12, wherein each of the plurality of video data transmitting parts comprises a first video data transmitting part and a second video data transmitting part which transmit the digital video data having even data and odd data of an 8-bit bus width to the panel driving part, in a case where the n-bit bus width is a 12-bit bus width and the m-bit is an 8-bit bus width and the k-bit is an 8-bit bus width; and
the pathway selection part which transmits the even data and the odd data of the digital video data to the first video data transmitting part and the second video data transmitting part, respectively, if the digital video data is output from the video data output part.

14. The display apparatus according to claim 13, wherein the panel driving part comprises a first video data receiving part which is connected to the first video data transmitting part and receives the even data of the digital video data according to a digital video data transmitting method;
a second video data receiving part which is connected to the second video data transmitting part and receives the odd data of the digital video data according to a digital video data transmitting method; and
a timing controller which drives the flat display panel by recognizing the digital video data received through the first video data receiving part as the even data, and by recognizing the digital video data received through the second video data receiving part as the odd data.
